(19) United States
(12) Patent Application Publication
(10) Pub. No.: US 2014/0195949 A1
(43) Pub. Date: Jul. 10, 2014

(54) CONTENT DELIVERY SYSTEM WITH SEQUENCE GENERATION MECHANISM AND METHOD OF OPERATION THEREOF

(71) Applicant: SAMSUNG ELECTRONICS CO., LTD., Gyeonggi-Do (KR)

(72) Inventor: Michael Baisuck, San Jose, CA (US)

(73) Assignee: SAMSUNG ELECTRONICS CO., LTD., Gyeonggi-Do (KR)

(21) Appl. No.: 13/736,196

(22) Filed: Jan. 8, 2013

(51) Int. Cl. G06F 3/0481

(52) U.S. Cl. CPC G06F 3/0481
USPC 715/771

(57) ABSTRACT

A method of operation of a content delivery system includes: determining an activity pattern based on an access input; generating an access sequence based on the activity pattern; and generating a notification otherwise the access sequence is executed for displaying on a device.

### TECHNICAL FIELD

An embodiment of the present invention relates generally to a content delivery system, and more particularly to a system for sequence generation mechanism.

### BACKGROUND

Modem portable consumer and industrial electronics, especially client devices such as navigation systems, cellular phones, portable digital assistants, and combination devices are providing increasing levels of functionality to support modem life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide personalized content through a mobile device, such as a cell phone, smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Content delivery system and personalized content services enabled systems have been incorporated in automobiles, notebooks, handheld devices, and other portable products. Today, these systems aid users by incorporating available, real-time relevant information, such as advertisement, entertainment, local businesses, or other points of interest (POI).

Thus, a need still remains for a content delivery system with sequence generation mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a method of operation of a content delivery system including: determining an activity pattern based on an access input; generating an access sequence based on the activity pattern; and generating a notification otherwise the access sequence is executed for displaying on a device.

An embodiment of the present invention provides a method of operation of a content delivery system including: determining an activity pattern based on an access input; generating an access sequence based on the activity pattern for sequencing the access input; and generating a notification otherwise the access sequence is executed for displaying on a device.

An embodiment of the present invention provides a content delivery system including: a behavior module for determining an activity pattern based on an access input; a build module, coupled to the behavior module, for generating an access sequence based on the activity pattern; a notifier module, coupled to the build module, for generating a notification otherwise the access sequence is executed for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a content delivery system with sequence generation mechanism in an embodiment of the present invention.

FIG. 2 is a first example of a display interface of the first device displaying a content.

FIG. 3 is a second example of the display interface of the first device 102 displaying the content.

FIG. 4 is a third example of the display interface of the first device displaying the content.

FIG. 5 is an example of the display interface of the first device of FIG. 1 displaying the context established by an environmental condition.

FIG. 6 is an exemplary block diagram of the content delivery system.

FIG. 7 is a control flow of the content delivery system.

FIG. 8 is a flow chart of a method of operation of a content delivery system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures. is arbitrary for the most part. Generally, the invention can be operated in any orientation.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

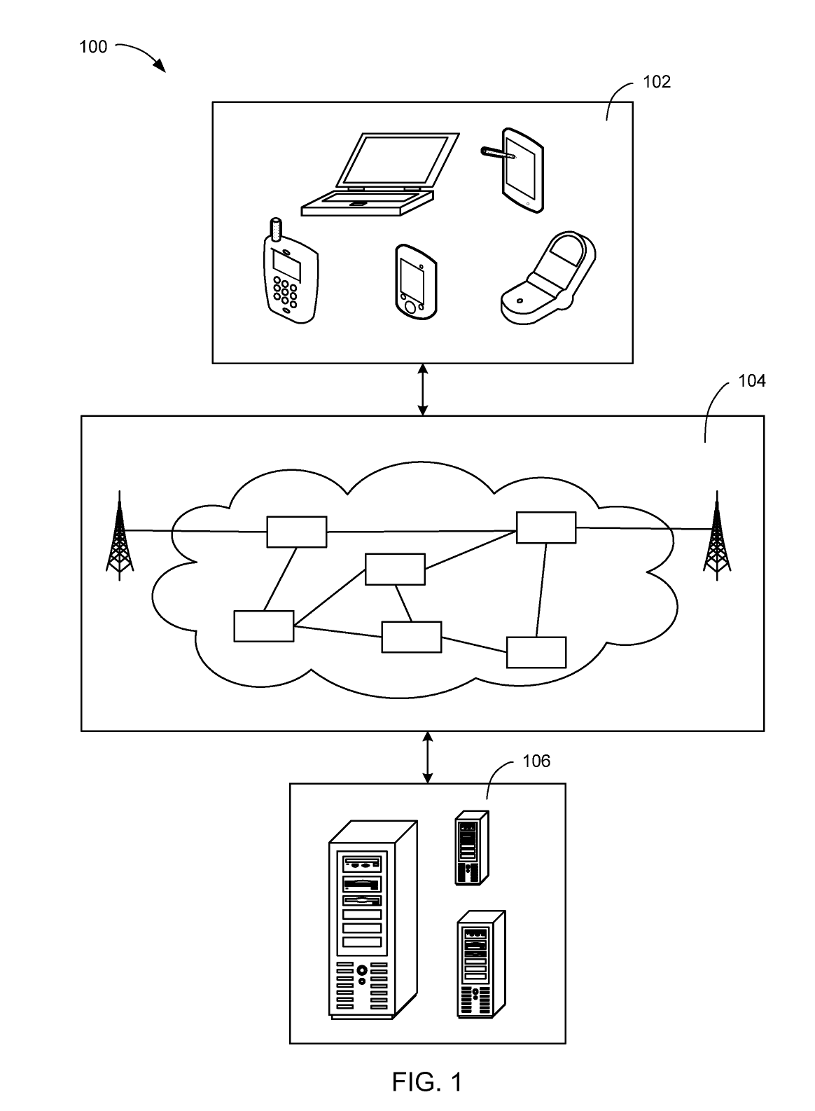

Referring now to FIG. 1, therein is shown a content delivery system 100 with sequence generation mechanism in an embodiment of the present invention. The content delivery system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, wearable digital device, tablet, notebook computer, television (TV), automotive telematic communication system, or other multi-functional mobile communication or entertainment device. The first device 102 can be a standalone device, or can be incorporated with a vehicle, for example a car, truck, bus, aircraft, boat/vessel, or train. The first device 102 can couple to the communication path 104 to communicate with the second device 106.

For illustrative purposes, the content delivery system 100 is described with the first device 102 as a display device, although it is understood that the first device 102 can be different types of devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Android™ smartphone, or Windows™ platform smartphone.

For illustrative purposes, the content delivery system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, aircraft, boat/vessel, or train.

Also for illustrative purposes, the content delivery system 100 is shown with the second device 106 and the first device 102 as end points of the communication path 104, although it is understood that the content delivery system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, wireless High-Definition Multimedia Interface (HDMI), Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

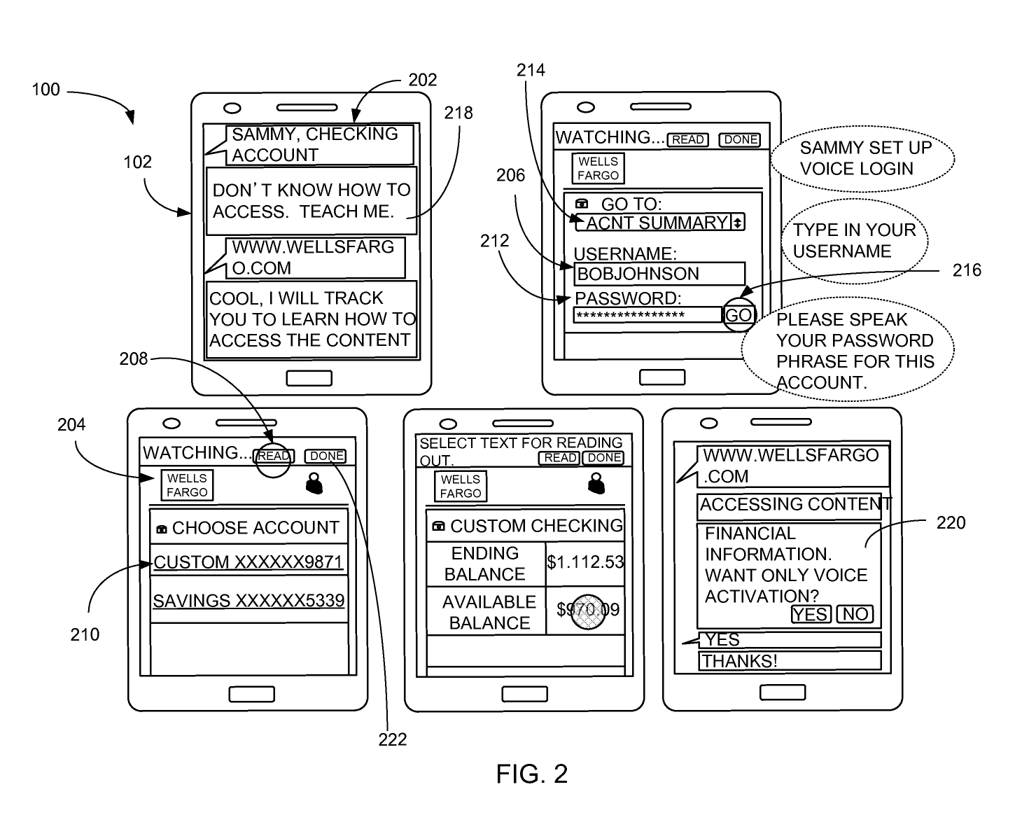

Referring now to FIG. 2, therein is shown a first example of a display interface 202 of the first device 102 displaying a content 204. The figures for the display interface 202 are illustrated in an order of sequence. For example, the sequence can start from the top left figure proceeding to the top right figure. Then moving to the bottom left figure proceeding to the bottom right figure. For clarity and brevity, the discussion of the present invention will focus on the first device 102 displaying the result generated by the content delivery system 100. However, the second device 106 and the first device 102 can be discussed interchangeably.

The content 204 is defined as information accessed by the user of the first device 102, the second device 106 of FIG. 1, or a combination thereof. For example, the content 204 can represent a website for financial institution, such Wells Fargo™, an American bank. For a different example, the content 204 can represent an application running on the first device 102 representing a smartphone or a tablet. More specifically, the content 204 can represent an application for selling concert performance tickets.

The content 204 can include an input field 206. The input field 206 can represent an area within the content 204 where the user, the content delivery system 100, or a combination thereof can make an access input 208. The access input 208 can represent an entry made by the user on the first device 102, the content delivery system 100, or a combination thereof. For example, the access input 208 can represent a text entry into the input field 206. For another example, the access input 208 can selection of the hypertext link.

The input field 206 can include an input type 210, a field type 212, a field functionality 222, or a combination thereof. The input type 210 is defined as a category of entry that the access input 208 can be made for the input field 206. For example, the input field 206 can represent a text field, a dropdown list, a hypertext link, a button, or a combination thereof. For another example, the input field 206 representing the dropdown list can include a plurality of a field selection 214. The field selection 214 can represent a choice of value available for the user, the content delivery system 100, or a combination thereof to select for entering the access input 208.

The field type 212 is defined as a classification of the input field 206. For example, the field type 212 can represent the input field 206 for inputting confidential information, non-confidential information, or a combination thereof. For a specific example, the field type 212 can represent username input field, password input field, or a combination thereof. For a different example, the field type 212 can be represented by a tag label of the input field 206. The field type 212 can be classified by a markup language, such as the extensible markup language (XML). A tag label representing the XML can classify the field type 212 of the input field 206 to represent a checking account balance.

The field functionality 222 is defined as an executable event for the input field 206. For example, the input field 206 can represent a button. The field functionality 222 of the button can represent an invocation of an event to log into a page on the content 204 after entering the username and password. A tag label representing the XML can define the field functionality 222 for the input field 206.

The access input 208 can be sequenced to generate an access sequence 216. The access sequence 216 is defined as combination of the access input 208 sequenced in the order which the access input 208 was made into the first device 102. For example, the access sequence 216 can represent a plurality of the access input 208 for accessing the checking account information on the content 204 representing Wells Fargo™. More specifically, the access sequence 216 can represent the plurality of the access input 208 in the order of entering username, password, and selecting the “Go” button to access the checking account information on the Wells Fargo™ website.

The content delivery system 100 can display a notification 218 on the display interface 202 to notify the user. The notification 218 is defined as information generated by the content delivery system 100 to inform the user. The notification 218 can include an interactive message 220. The interactive message 220 is defined as the notification 218 generated while the content delivery system 100 is tracking the access input 208. For example, the interactive message 220 can represent a message to notify the user that the content delivery system 100 is tracking the access input 208 to record the sequence which the access input 208 is entered on the first device 102.

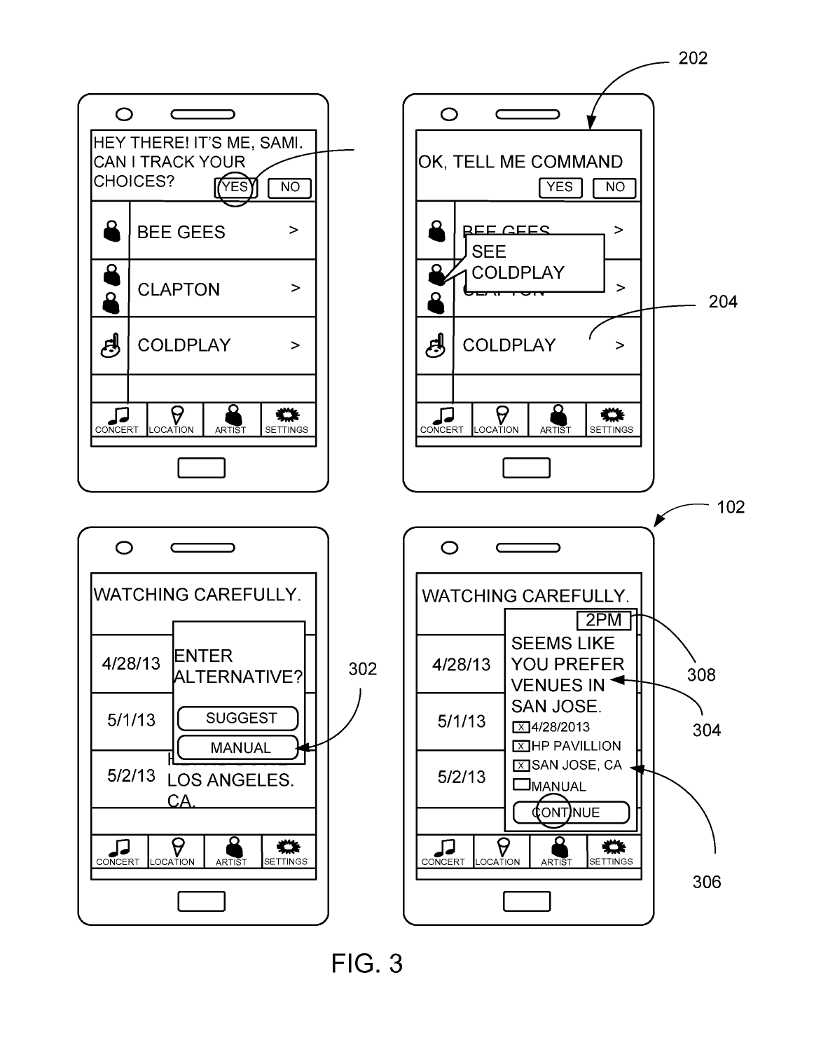

Referring now to FIG. 3, therein is shown a second example of the display interface 202 of the first device 102 displaying the content 204. The figures for the display interface 202 are illustrated in an order of sequence. For example, the sequence can start from the top left figure proceeding to the top right figure. Then moving to the bottom left figure proceeding to the bottom right figure.

The access input 208 can be tracked to generate an activity pattern 302. The activity pattern 302 is defined a historical tendency of the access input 208 made on the first device 102. For example, the activity pattern 302 can include the order in which the access input 208 was made on the content 204. For another example, the activity pattern 302 can include the uniform resource location (URL) entered by the user of the first device 102 to access the content 204.

For a different example, the activity pattern 302 can include the context 304 in which the access input 208 was made on the first device 102. The context 304 is defined as a situation, environment, or a combination thereof where the user of the first device 102 is situated. For example, the context 304 can represent a geographic location 306 where the crime rate is low. For another example, the context 304 can represent a professional setting or a private setting. The geographic location 306 is defined as the physical location where the first device 102 is located. The context 304 can include an input time 308, which can represent the time of day in which the access input 208 was entered on the first device 102.

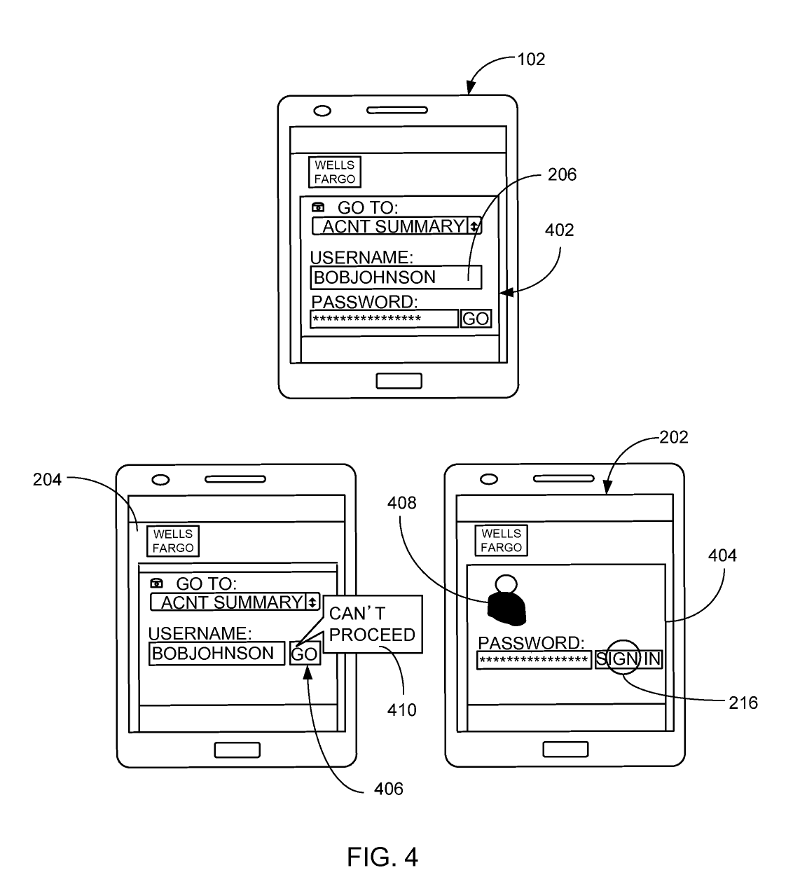

Referring now to FIG. 4, therein is shown a third example of the display interface 202 of the first device 102 displaying the content 204. The figures for the display interface 202 are illustrated in an order of sequence. For example, the sequence can start from bottom left figure proceeding to the bottom right figure. Furthermore, the top figure can represent a previous layout 402 of the content 204. And the bottom figures can represent a current layout 404 of the content 204.

The content 204 can be displayed on the display interface 202 as the previous layout 402, the current layout 404, or a combination thereof. The current layout 404 can represent the display format of the content 204 displayed to the user when the user is entering the access input 208. The previous layout 402 can represent the display format of the content 204 displayed to the user in the past. For example, the previous layout 402 and the current layout 404 can be designed using the same display format. More specifically, the previous layout 402 and the current layout 404 can be designed using hypertext markup language (HTML), XML, or a combination thereof.

A layout difference 406 is defined as a dissimilarity between the previous layout 402 and the current layout 404. For example, the layout difference 406 can represent the difference in the placement of the input field 206 on the content 204. For another example, the layout difference 406 can represent the difference in the field selection 214 available in the input field 206.

The execution of the access sequence 216 of FIG. 2 can be validated based on a user's identity 408. The user's identity 408 is defined as a characteristic of the user of the first device 102. For example, the user's identity 408 can represent the user's voice. For a different example, the user's identity 408 can represent a facial feature of the user. The user's identity 408 can be displayed on the display interface 202. For another example, the user's identity 408 can represent a password for the user or the users of the first device 102 to edit, execute, or a combination thereof the access sequence 216.

The notification 218 can include an alert message 410. The alert message 410 is defined as the notification 218 to inform the inability to continue executing the access sequence 216. For example, the alert message 410 can represent a message that input field 206 on the content 204 had changed, thus, the access sequence 216 cannot execute in the order that the access input 208 was tracked.

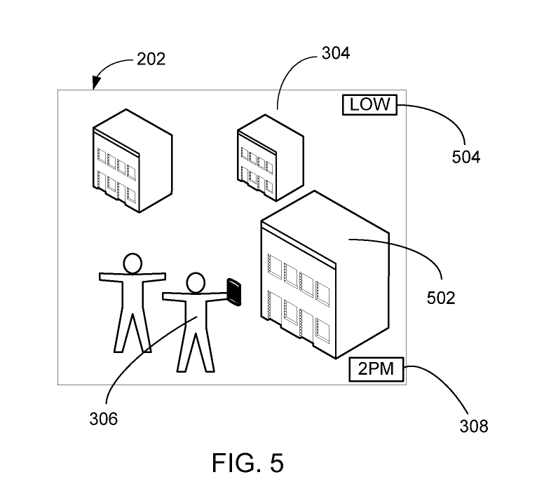

Referring now to FIG. 5, therein is shown an example of the display interface 202 of the first device 102 of FIG. 1 displaying the context 304 established by an environmental condition 502. The environmental condition 502 is defined as a factor or factors that establish the context 304. For example, the environmental condition 502 can include a safety level 504, the geographic location 306, the input time 308, or a combination thereof.

The safety level 504 is defined as the level of harm that the user of the first device 102 is exposed to. For example, the safety level 504 can represent the crime rate of the geographic location 306. For another example, the safety level 504 can represent the crime rate of when the input time 308 was logged.

More specifically, the input time 308 can represent 12 PM. The safety level 504 of the input time 308 representing 12 PM can be historically low crime rate level. As a result, the context 304 where the user of the first device 102 entered the access input 208 can represent a safe environment.

For another example, the environmental condition 502 can be established based on the geographic location 306. The geographic location 306 can represent an address for user's work place. The environmental condition 502 can represent a working environment. As a result, the context 304 where the user of the first device 102 is located can represent a professional setting.

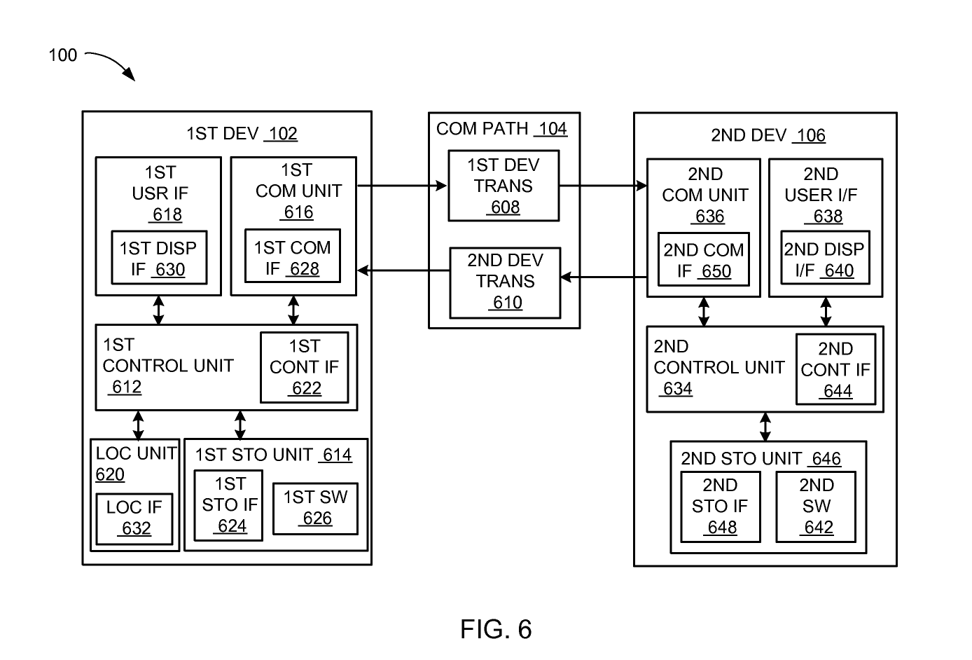

Referring now to FIG. 6, therein is shown an exemplary block diagram of the content delivery system 100. The content delivery system 100 can include the first device 102, the communication path 104, and the second device 106. The first device 102 can send information in a first device transmission 608 over the communication path 104 to the second device 106. The second device 106 can send information in a second device transmission 610 over the communication path 104 to the first device 102.

For illustrative purposes, the content delivery system 100 is shown with the first device 102 as a client device, although it is understood that the content delivery system 100 can have the first device 102 as a different type of device. For example, the first device 102 can be a server having a display interface.

Also for illustrative purposes, the content delivery system 100 is shown with the second device 106 as a server, although it is understood that the content delivery system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of the present invention.

The first device 102 can include a first control unit 612, a first storage unit 614, a first communication unit 616, a first user interface 618, and a location unit 620. The first control unit 612 can include a first control interface 622. The first control unit 612 can execute a first software 626 to provide the intelligence of the content delivery system 100.

The first control unit 612 can be implemented in a number of different manners. For example, the first control unit 612 can be a processor, an application specific integrated circuit (ASIC) an embedded processor, a microprocessor, a hardware control logic, a hardware finite state machine (FSM), a digital signal processor (DSP), or a combination thereof. The first control interface 622 can be used for communication between the first control unit 612 and other functional units in the first device 102. The first control interface 622 can also be used for communication that is external to the first device 102.

The first control interface 622 can receive information from the other functional units or from external sources, or can transmit information to the other functional units or to external destinations. The external sources and the external destinations refer to sources and destinations physically separate from to the first device 102.

The first control interface 622 can be implemented in different ways and can include different implementations depending on which functional units or external units are being interfaced with the first control interface 622. For example, the first control interface 622 can be implemented with a pressure sensor, an inertial sensor, a microelectromechanical system (MEMS), optical circuitry, waveguides, wireless circuitry, wireline circuitry, or a combination thereof.

The location unit 620 can generate location information, current heading, and current speed of the first device 102, as examples. The location unit 620 can be implemented in many ways. For example, the location unit 620 can function as at least a part of a global positioning system (GPS), an inertial navigation system, a cellular-tower location system, a pressure location system, or any combination thereof.

The location unit 620 can include a location interface 632. The location interface 632 can be used for communication between the location unit 620 and other functional units in the first device 102. The location interface 632 can also be used for communication that is external to the first device 102.

The location interface 632 can receive information from the other functional units or from external sources, or can transmit information to the other functional units or to external destinations. The external sources and the external destinations refer to sources and destinations physically separate from the first device 102.

The location interface 632 can include different implementations depending on which functional units or external units are being interfaced with the location unit 620. The location interface 632 can be implemented with technologies and techniques similar to the implementation of the first control interface 622.

The first storage unit 614 can store the first software 626. The first storage unit 614 can also store the relevant information, such as advertisements, points of interest (POI), navigation routing entries, or any combination thereof. The relevant information can also include news, media, events, or a combination thereof from the third party content provider.

The first storage unit 614 can be a volatile memory, a nonvolatile memory, an internal memory, an external memory, or a combination thereof. For example, the first storage unit 614 can be a nonvolatile storage such as non-volatile random access memory (NVRAM), Flash memory, disk storage, or a volatile storage such as static random access memory (SRAM).

The first storage unit 614 can include a first storage interface 624. The first storage interface 624 can be used for communication between and other functional units in the first device 102. The first storage interface 624 can also be used for communication that is external to the first device 102.

The first storage interface 624 can receive information from the other functional units or from external sources, or can transmit information to the other functional units or to external destinations. The external sources and the external destinations refer to sources and destinations physically separate from the first device 102.

The first storage interface 624 can include different implementations depending on which functional units or external units are being interfaced with the first storage unit 614. The first storage interface 624 can be implemented with technologies and techniques similar to the implementation of the first control interface 622.

The first communication unit 616 can enable external communication to and from the first device 102. For example, the first communication unit 616 can permit the first device 102 to communicate with the second device 106 of FIG. 1, an attachment, such as a peripheral device or a computer desktop, and the communication path 104.

The first communication unit 616 can also function as a communication hub allowing the first device 102 to function as part of the communication path 104 and not limited to be an end point or terminal unit to the communication path 104. The first communication unit 616 can include active and passive components, such as microelectronics or an antenna, for interaction with the communication path 104.

The first communication unit 616 can include a first communication interface 628. The first communication interface 628 can be used for communication between the first communication unit 616 and other functional units in the first device 102. The first communication interface 628 can receive information from the other functional units or can transmit information to the other functional units.

The first communication interface 628 can include different implementations depending on which functional units are being interfaced with the first communication unit 616. The first communication interface 628 can be implemented with technologies and techniques similar to the implementation of the first control interface 622.

The first user interface 618 allows a user (not shown) to interface and interact with the first device 102. The first user interface 618 can include an input device and an output device. Examples of the input device of the first user interface 618 can include a keypad, a touchpad, soft-keys, a keyboard, a microphone, an infrared sensor for receiving remote signals, or any combination thereof to provide data and communication inputs.

The first user interface 618 can include a first display interface 630. The first display interface 630 can include a display, a projector, a video screen, a speaker, or any combination thereof.

The first control unit 612 can operate the first user interface 618 to display information generated by the content delivery system 100. The first control unit 612 can also execute the first software 626 for the other functions of the content delivery system 100, including receiving location information from the location unit 620. The first control unit 612 can further execute the first software 626 for interaction with the communication path 104 via the first communication unit 616.

The second device 106 can be optimized for implementing the embodiment of the present invention in a multiple device embodiment with the first device 102. The second device 106 can provide the additional or higher performance processing power compared to the first device 102. The second device 106 can include a second control unit 634, a second communication unit 636, and a second user interface 638.

The second user interface 638 allows a user (not shown) to interface and interact with the second device 106. The second user interface 638 can include an input device and an output device. Examples of the input device of the second user interface 638 can include a keypad, a touchpad, soft-keys, a keyboard, a microphone, or any combination thereof to provide data and communication inputs. Examples of the output device of the second user interface 638 can include a second display interface 640. The second display interface 640 can include a display, a projector, a video screen, a speaker, or any combination thereof.

The second control unit 634 can execute a second software 642 to provide the intelligence of the second device 106 of the content delivery system 100. The second software 642 can operate in conjunction with the first software 626. The second control unit 634 can provide additional performance compared to the first control unit 612.

The second control unit 634 can operate the second user interface 638 to display information. The second control unit 634 can also execute the second software 642 for the other functions of the content delivery system 100, including operating the second communication unit 636 to communicate with the first device 102 over the communication path 104.

The second control unit 634 can be implemented in a number of different manners. For example, the second control unit 634 can be a processor, an embedded processor, a microprocessor, hardware control logic, a hardware finite state machine (FSM), a digital signal processor (DSP), or a combination thereof.

The second control unit 634 can include a second control interface 644. The second control interface 644 can be used for communication between the second control unit 634 and other functional units in the second device 106. The second control interface 644 can also be used for communication that is external to the second device 106.

The second control interface 644 can receive information from the other functional units or from external sources, or can transmit information to the other functional units or to external destinations. The external sources and the external destinations refer to sources and destinations physically separate from the second device 106.

The second control interface 644 can be implemented in different ways and can include different implementations depending on which functional units or external units are being interfaced with the second control interface 644. For example, the second control interface 644 can be implemented with a pressure sensor, an inertial sensor, a microelectromechanical system (MEMS), optical circuitry, waveguides, wireless circuitry, wireline circuitry, or a combination thereof.

A second storage unit 646 can store the second software 642. The second storage unit 646 can also store the relevant information, such as advertisements, points of interest (POI), navigation routing entries, or any combination thereof. The second storage unit 646 can be sized to provide the additional storage capacity to supplement the first storage unit 614.

For illustrative purposes, the second storage unit 646 is shown as a single element, although it is understood that the second storage unit 646 can be a distribution of storage elements. Also for illustrative purposes, the content delivery system 100 is shown with the second storage unit 646 as a single hierarchy storage system, although it is understood that the content delivery system 100 can have the second storage unit 646 in a different configuration. For example, the second storage unit 646 can be formed with different storage technologies forming a memory hierarchal system including different levels of caching, main memory, rotating media, or off-line storage.

The second storage unit 646 can be a volatile memory, a nonvolatile memory, an internal memory, an external memory, or a combination thereof. For example, the second storage unit 646 can be a nonvolatile storage such as non-volatile random access memory (NVRAM), Flash memory, disk storage, or a volatile storage such as static random access memory (SRAM).

The second storage unit 646 can include a second storage interface 648. The second storage interface 648 can be used for communication between other functional units in the second device 106. The second storage interface 648 can also be used for communication that is external to the second device 106.

The second storage interface 648 can receive information from the other functional units or from external sources, or can transmit information to the other functional units or to external destinations. The external sources and the external destinations refer to sources and destinations physically separate from the second device 106.

The second storage interface 648 can include different implementations depending on which functional units or external units are being interfaced with the second storage unit 646. The second storage interface 648 can be implemented with technologies and techniques similar to the implementation of the second control interface 644.

The second communication unit 636 can enable external communication to and from the second device 106. For example, the second communication unit 636 can permit the second device 106 to communicate with the first device 102 over the communication path 104.

The second communication unit 636 can also function as a communication hub allowing the second device 106 to function as part of the communication path 104 and not limited to be an end point or terminal unit to the communication path 104. The second communication unit 636 can include active and passive components, such as microelectronics or an antenna, for interaction with the communication path 104.

The second communication unit 636 can include a second communication interface 650. The second communication interface 650 can be used for communication between the second communication unit 636 and other functional units in the second device 106. The second communication interface 650 can receive information from the other functional units or can transmit information to the other functional units.

The second communication interface 650 can include different implementations depending on which functional units are being interfaced with the second communication unit 636. The second communication interface 650 can be implemented with technologies and techniques similar to the implementation of the second control interface 644.

The first communication unit 616 can couple with the communication path 104 to send information to the second device 106 in the first device transmission 608. The second device 106 can receive information in the second communication unit 636 from the first device transmission 608 of the communication path 104.

The second communication unit 636 can couple with the communication path 104 to send information to the first device 102 in the second device transmission 610. The first device 102 can receive information in the first communication unit 616 from the second device transmission 610 of the communication path 104. The content delivery system 100 can be executed by the first control unit 612, the second control unit 634, or a combination thereof. For illustrative purposes, the second device 106 is shown with the partition having the second user interface 638, the second storage unit 646, the second control unit 634, and the second communication unit 636, although it is understood that the second device 106 can have a different partition. For example, the second software 642 can be partitioned differently such that some or all of its function can be in the second control unit 634 and the second communication unit 636. Also, the second device 106 can include other functional units not shown in FIG. 6 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the content delivery system 100 is described by operation of the first device 102 and the second device 106. It is understood that the first device 102 and the second device 106 can operate any of the modules and functions of the content delivery system 100. For example, the first device 102 is described to operate the location unit 620, although it is understood that the second device 102 can also operate the location unit 620.

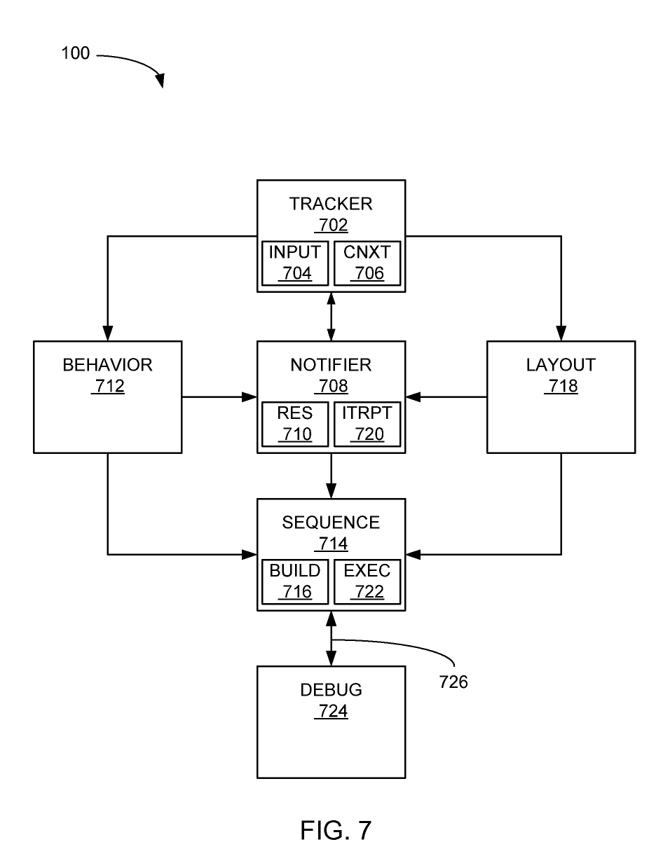

Referring now to FIG. 7 therein is shown a control flow of the content delivery system 100. The content delivery system 100 can include a tracker module 702. The tracker module 702 tracks the access input 208 of FIG. 2. For example, the tracker module 702 can track the access input 208 made by the user on the first device 102 for generating the access sequence 216 of FIG. 2.

The tracker module 702 can track the access input 208 in a number of ways. The tracker module 702 can include an input module 704. The input module 704 tracks the access input 208. For example, the input module 704 can track the access input 208 based on the input type 210 of FIG. 2, the field type 212 of FIG. 2, the content 204 of FIG. 2, or a combination thereof for logging the access input 208 for the content 204.

For a specific example, the input module 704 can track the access input 208 by determining the input type 210, the field type 212, the content 204, or a combination thereof for the access input 208 made on the first device 102. More specifically, the content 204 can represent a website for Wells Fargo™. The content 204 can include the input field 206 of FIG. 2. The input field 206 can include the input type 210 of the text field, the dropdown list, the button, the link, or a combination thereof. Furthermore, the input field 206 can include the field type 212 such as the username input field or the password input field.

The access input 208 representing text entries can be made on the instances of the input field 206. The first value of the text entries can represent “username123” for one of the input field 206. Another value of the text input can represent “password123” for the other instance of the input field 206. If the access input 208 was typed into the input field 206, the input type 210 can represent the text field. The input module 704 can determine the value of the access input 208 is a text based on the input type 210 of the input field 206. Furthermore, the input module 704 can determine the value of the access input 208 to be the username or password based on the field type 212 for the input field 206.

As a result, the input module 704 can log the access input 208 of “username123” and “password 123” as the username and password for logging into the content 204 representing Wells Fargo™ website. The input module 704 can log the access input 208 into the first storage unit 614 of FIG. 6.

The tracker module 702 can include a context module 706. The context module 706 determines the context 304 of FIG. 3. For example, the context module 706 can determine the context 304 surrounding the user of the first device 102 for making the access input 208.

The context module 706 can determine the context 304 in a number of ways. The context module 706 can determine the context 304 based on analyzing the environmental condition 502 of FIG. 5. The environmental condition 502 can include the safety level 504 of FIG. 5, the geographic location 306 of FIG. 3, the input time 308 of FIG. 3, or a combination thereof. For example, the context module 706 can determine the context 304 based on the safety level 504, the geographic location 306, the input time 308, or a combination thereof.

For a specific example, the context module 706 can determine the geographic location 306 of FIG. 3 of the user via the location unit 620 of FIG. 6 by determining the physical location of the first device 102. By determining the geographic location 306, the context module 706 can track where the access input 208 was made on the first device 102. The context module 706 can determine the input time 308 based on the time of day when the access input 208 was entered on the first device 102. The context module 706 can determine the input time 308 via the first control interface 622 of FIG. 6 by receiving a timestamp when the access input 208 was made on the content 204. The timestamp can be generated by external sources, such as a website, or the application running on the first device 102. The context module 706 can determine the content 204 based on the URL accessed from the first device 102 via the first control interface 622.

The safety level 504 can represent the crime rate for the geographic location 306, the crime rate at the time of the day for the input time 308, or a combination thereof. The context module 706 can determine the safety level 504 by accessing, via the first control interface 622, the crime rate information for the geographic location 306, the input time 308, or a combination thereof provided from the external sources, such as the government database.

The geographic location 306 determined can represent Palo Alto, Calif. The safety level 504 for Palo Alto can be low crime rate. The input time 308 can represent 2 PM. The safety level 504 for 2 PM can represent a time of the day when the crime rate is low. The content 204 can represent Wells Fargo™ website. The content 204 can represent a banking website that contains confidential financial information. The context module 706 can determine the context 304 based on factoring the geographic location 306, the input time 308, the type of the content 204 accessed, or a combination thereof. More specifically, the context module 706 can determine the context 304 to be safe surrounding based on locating the user in the geographic location 306 with the safety level 504 of a low crime rate, determining the input time 308 when access input 208 was made to be the safety level 504 of low crime rate, and the content 204 accessed by the user to be a confidential financial information.

The context module 706 can log the context 304 along with the corresponding instance of the access input 208 in to the first storage unit 614. The tracker module 702 can send the access input 208, the context 304, or a combination thereof to a notifier module 708.

The content delivery system 100 can include the notifier module 708, which can be coupled to the tracker module 702. The notifier module 708 generates the notification 218 of FIG. 2. For example, the notifier module 708 can generate the notification 218 for notifying the user of the first device 102.

The notifier module 708 can include a response module 710. The response module 710 generates the notification 218 representing the interactive message 220 of FIG. 2. For example, the response module 710 can generate the interactive message 220 based on the access input 208 made on the first device 102. More specifically, the response module 710 can generate the interactive message 220 in response to the tracking of the access input 208 by the input module 704.

The response module 710 can generate the interactive message 220 when the access input 208 is being tracked for the first time for the generation of the access sequence 216. For example, the user can access the content 204 representing Wells Fargo™ website. If the access sequence 216 is not generated for the content 204, the response module 710 can generate the interactive message 220 to notify the user that the input module 704 will track the access input 208 for generating the access sequence 216.

For a specific example, the access input 208 can be made to access the checking account information from the Wells Fargo™ website. As the access input 208 for username, password, and the checking account are entered or selected, the response module 710 can generate the interactive message 220, such as “I'm watching carefully,” to notify the user that the input module 704 is tracking the access input 208.

In addition to notifying the user that the access input 208 is being tracked, the response module 710 can generate the interactive message 220 for receiving the access input 208. More specifically, the interactive message 220 can include the selection options, such as “read” or “done,” for receiving the access input 208. For example, the content 204 can display the account balance information on the first device 102. The response module 710 can generate the interactive message 220 to ask whether to generate the audio version of the notification 218 for reading out the account balance information to the user.

The response module 710 can generate the interactive message 220 based on the field type 212 disclosed in the content 204. For a specific example, the response module 710 can determine whether to generate the audio version of the notification 218 based on the field type 212. As discussed previously, if the field type 212 represents checking account balance, the response module 710 can generate the interactive message 220 asking whether the user would like the checking account balance read out as the audio instance of the notification 218. In contrast, the response module 710 can avoid generating the interactive message 220 asking whether to generate the audio instance of the notification 218 if the field type 212 represents confidential information, such as a password. The response module 710 can determine the generation of the audio version of the notification 218 based on the field type 212 not representing the content 204 disclosing confidential information.

For another example, the response module 710 can generate the interactive message 220 based on the environmental condition 502. More specifically, the response module 710 can generate the interactive message 220 based on the safety level 504 of the geographic location 306, the input time 308, or a combination thereof. If the safety level 504 for the geographic location 306 is determined to be low crime rate, the response module 610 can generate the interactive message 220 asking whether the user would like the audio version of the notification 218 be created. In contrast, if the safety level 504 for the input time 308 is determined to be high crime rate, the response module 710 can avoid generating the interactive message 220 for asking whether to create the audio version of the notification 218. The response module 710 can display the interactive message 220 via the first display interface 630 of FIG. 6. The input module 704 can receive the access input 208 by the user selecting the selection options on the interactive message 220.

The content delivery system 100 can include a behavior module 712, coupled to the tracker module 702. The behavior module 712 can receive the access input 208 and the context 304 from the tracker module 702. The behavior module 712 determines the activity pattern 302 of FIG. 3. For example, the behavior module 712 can determine the activity pattern 302 based on the access input 208 made within the context 304.

For a specific example, the context 304 can represent shopping for concert tickets. The content 204 can represent a concert ticketing website. The access input 208 can represent the selection of the artist performing, the location of the concert, and the day of the week when the concert is performing. The interactive message 220 can be displayed to the user offering suggestions. For example, if the tickets for the artist selected are unavailable, the interactive message 220 can include a suggestion with a different artist within the same genre, different location, different date, or a combination thereof. Details regarding the generation of the suggestion will be discussed below.

The behavior module 712 can determine the activity pattern 302 based on the access input 208 tracked. The tracked record of the access input 208 can indicate that the user tends to select the venue representing Hewlett Packard (HP) Pavilion in San Jose, Calif. The user also tends to select Friday night instead of Saturday night for the event day. Additionally, if the interactive message 220 offers a different artist, the user tends to select the artist suggested. The behavior module 712 can learn from the tendency of the access input 208 made using machine learning algorithms. As a result, the behavior module 712 can determine the activity pattern 302 based on the tendency of the access input 208.

More specifically, the activity pattern 302 can differ based on the context 304 where the user of the first device 102 is located. For a different example, the activity pattern 302 can also differ based on the content 204 accessed by the user. The behavior module 712 can determine the activity pattern 302 based on factoring the context 304 where the access input 208 was made. For a specific example, if the context 304 can represent the geographic location 306 with the safety level 504 representing a high crime rate, the user tends not to select the option presented by the interactive message 220 because the user is not at ease to consider a different option.

For a different example, if the content 204 can represent Wells Fargo™ website, the user may seek to get things done rather quickly and tend not to select the option presented by the interactive message 220 in the context 304 representing a high crime rate area. In contrast, if the content 204 represents a shopping site and the safety level 504 of the geographic location 306 to be a low crime rate, the access input 208 tracked can indicate the higher willingness by the user to select the option presented by the interactive message 220. Based on the context 304, the content 204, or a combination thereof, the behavior module 712 can determine the activity pattern 302 for the access input 208.

For another example, the behavior module 712 can determine the activity pattern 302 based on the order of the access input 208 made on the content 204, the field type 212, the input type 210, or a combination thereof. More specifically, the user can have the tendency to enter the field type 212 of password before the field type 212 of username. For a different example, the access input 208 can indicate that the user tends select the input type 210 of sidebar to scroll the entirety of the content 204 before making any selection. As a result, the behavior module 712 can generate the activity pattern 302 based on the activities performed on the content 204. The behavior module 712 can send the activity pattern 302 to a sequence module 714.

For illustrative purposes, the content delivery system 100 is shown with the response module 710 generating the interactive message 220 based on the access input 208, although it is under stood that the response module 710 can be operated differently. For example, the response module 710 can generate the interactive message 220 based on the activity pattern 302.

As discussed previously, the access input 208 for shopping for a concert ticket can be tracked. More specifically, the access input 208 representing the selection of artist, genre, location, day of the week, or a combination thereof can be tracked. The activity pattern 302 representing the access input 208 for purchasing the concert ticket can be generated as discussed above. As a result, based on the activity pattern 302, the user's tendency for purchasing the concert ticket can be determined.

Based on the activity pattern 302, the response module 710 can generate the interactive message 220 offering a suggestion for a different artist within the same genre, different location, different date, or a combination thereof if the first choice selection made by the user is unavailable. More specifically, by learning the user's tendency from the activity pattern 302, the response module 710 can generate the interactive message 220 with the field selection 214 of FIG. 2 the user may be interested in selecting instead of the first choice selection.

The content delivery system 100 can include the sequence module 714, which can be coupled to the behavior module 712. The sequence module 714 generates and executes the access sequence 216. For example, the sequence module 714 can generate the access sequence 216 based on the activity pattern 302 for executing the access sequence 216.

The sequence module 714 can include a build module 716. The build module 716 generates the access sequence 216. For example, the build module 716 can generate the access sequence 216 based on the activity pattern 302 for sequencing the access input 208 made on the first device 102.

The build module 716 can generate the access sequence 216 in a number of ways. For example, the build module 716 can generate the access sequence 216 based on the content 204. As discussed previously, the access input 208 can be tracked to log the sequence of entries necessary to access the checking account information on the content 204 representing Wells Fargo™ website. The build module 716 can generate the access sequence 216 for the specific instance of the content 204 by sequencing the activity pattern 302 of the access input 208 logged for the content 204.

For a different example, the build module 716 can generate the access sequence 216 based on the activity pattern 302 for the context 304. The activity pattern 302 for the same instance of the content 204 can differ based on the context 304. More specifically, the activity pattern 302 on the content 204 can indicate a fewer numbers of the access input 208 for the context 304 representing the safety level 504 of the geographic location 306 with a high crime rate as oppose to the context 304 representing the safety level 504 of the geographic location 306 with a lower crime rate. The build module 716 can generate the access sequence 216 in accordance to the context 304 where the user of the first device 102 is located.

It has been discovered that the content delivery system 100 can generate the access sequence 216 in accordance to the context 304. The customization of the access sequence 216 based on the context 304 can improve efficiency for accessing the content 204. As a result, the content delivery system 100 can enhance the user experience of using the first device 102 and the content delivery system 100.

The content delivery system 100 can include a layout module 718, which can be coupled to the tracker module 702. The layout module 718 determines the layout difference 406 of FIG. 4. For example, the layout module 718 can determine the layout difference 406 based on comparing the current layout 404 of FIG. 4 to the previous layout 402 of FIG. 4 of the content 204.

The layout module 718 can determine the layout difference 406 in a number of ways. For example, the layout module 718 can determine the layout difference 406 based on the location coordinate of the input field 206 on the content 204. The content 204 can represent Wells Fargo™ website. More specifically, in the previous layout 402, the input field 206 with the input type 210 representing a button of “Sign In” can be next to the input field 206 with the field type 212 representing the password input field. However, in the current layout 404, the input field 206 for the password is no longer on the same page of the content 204 as the input field 206 for the username. As a result, the button representing “Sign In” can be next to the input field 206 for the username. And the input field 206 for the password can be on the subsequent page of the content 204. The layout module 718 can determine the layout difference 406 based on difference of the input field 206 available on the previous layout 402 and the current layout 404 of the content 204.

For a different example, the layout module 718 can determine the layout difference 406 based on the field selection 214 of the input field 206. In the previous layout 402, the input field 206 can represent the input type 210 of a dropdown list. And the list can include the following instances of the field selection 214: Date, Venue, City, and Manual Option. In the current layout 404, the input field 206 can include the field selection 214 of Date, Genre, Venue, City, and the Manual Option. The layout module 718 can determine the layout difference 406 based on the difference of the field selection 214 available between the previous layout 402 and the current layout 404. The layout module 718 can send the layout difference 406 to the notifier module 708 and the sequence module 714.

For another example, the layout module 718 can determine the layout difference 406 based on the field functionality 222. The field functionality 222 of the input field 206 representing a button for the previous layout 402 can be logging into the content 204 after entering the username and password. However, the field functionality 222 of the button in the current layout 404 can be updated to changing the page on the content 204. The layout module 718 can determine the layout difference 406 based on the changes in the tag label classifying the event that is executable for the input field 206.

For illustrative purposes, the content delivery system 100 is shown with the notifier module 708 generating the interactive message 220, although it is understood that the notifier module 708 can be operated differently. For example, the notifier module 708 can generate the notification 218 representing the alert message 410 of FIG. 4.

The notifier module 708 can include an interruption module 720. The interruption module 720 generates the alert message 410. For example, the interruption module 720 can generate the alert message 410 based on the layout difference 406 for notifying the user of the inability to execute the access sequence 216.

The interruption module 720 can generate the alert message 410 in a number of ways. For example, the interruption module 720 can generate the alert message 410 based on the layout difference 406, the activity pattern 302, or a combination thereof. More specifically, the layout difference 406 can represent the difference in the field type 212 between the previous layout 402 and the current layout 404. The field type 212 can change from the static instance of the input field 206 to the dynamic instance of the input field 206. The input field 206 can represent the input field 206 of the dropdown list having the field selection 214 that was initially set and static. Static can represent the choices available in the field selection 214 is fixed and does not change. However, the input field 206 can change to the dynamic instance, where the field selection 214 available can dynamically change. The interruption module 720 can generate the alert message 410 based on the difference in the field type 212 to notify the user that the execution of the access sequence 216 may not be able to complete because of the unknown instance of the field selection 214 is now available in the input field 206. Moreover, the interruption module 720 can generate the alert message 410 to request the access input 208 to select from the field selection 214 continue with the process of furtherer accessing the content 204.

For further example, the interruption module 720 can generate the alert message 410 to notify how far in the access sequence 216 that the sequence module 714 can execute. More specifically, the interruption module 720 can determine the extent of the access sequence 216 that can be executed based on the layout difference 406. For example, the access sequence 216 can be executed up to the point in the content 204 where the layout difference 406 is determined. The interruption module 720 can generate the alert message 410 indicating the point in the access sequence 216 where the access input 208 from user is required on the first device 102

For a different example, the interruption module 720 can generate the alert message 410 based on the activity pattern 302. More specifically, the interruption module 720 can generate the alert message 410 based on the context 304 where the user is located. The context 304 can represent the geographic location 306 with the safety level 504 of low crime rate. The activity pattern 302 can indicate that the user tends to manually enter the access input 208 on the first device 102 rather than executing the access sequence 216. The tendency can be based on the comfort level of the user spending time to enter the access input 208. The interruption module 720 can generate the alert message 410 to request whether to execute the access sequence 216 or enter the access input 208 manually if the context 304 where the user is located is in the geographic location 306 with the safety level 504 of low crime rate.

For illustrative purposes, the sequence module 714 can generate the access sequence 216, although it is understood that the sequence module 714 can be operated differently. For example, the sequence module 714 can execute the access sequence 216.

The sequence module 714 can include an execution module 722. The execution module 722 executes the access sequence 216. The execution module 722 can execute the access sequence 216 in a number of ways. For example, the execution module 722 can execute the access sequence 216 based on the user's identity 408 of FIG. 4 being validated. More specifically, the access input 208 can represent an oral command by the user to the first device 102. The oral command can represent “checking account information.” The access sequence 216 generated as discussed above can be triggered to access the content 204 representing Wells Fargo™ website.

The execution module 722 can validate the user's identity 408 based on comparing the user's voice to the voice stored in the first storage unit 614. The execution module 722 can also validate the user's identity 408 based on comparing the user's facial feature to the facial feature information stored in the first storage unit 614. More specifically, the first device 102 can include a camera to capture the user's face and perform a comparison to the information stored in the first device 102. Once the user's identity 408 is validated, the execution module 722 can execute the access sequence 216 to access the content 204.

For a different example, the execution module 722 can execute the access sequence 216 by temporary storing the access input 208. The content 204 can represent a database website, such as LexisNexis™. Unlike the search engine, such as Google™, the input field 206 for entering the access input 208 representing a search term for LexisNexis™ can be displayed after entering the login information. The access input 208 can represent a voice entry for the search term, which the search term can be logged, thus, temporarily stored. The voice entry can be validated as the user's identity 408 which triggers the access sequence 216 for performing the query on LexisNexis™. The access sequence 216 can include the sequence of entering the username, password, and selecting the page in LexisNexis™ for searching a term. Further, after reaching the page for searching for the search term, the execution module 722 can retrieve the access input 208 representing the search term for populating the search term in the input field 206 to perform the search.

For another example, the execution module 722 can execute the access sequence 216 based on the availability of the alert message 410. More specifically, if the alert message 410 is generated to indicate the layout difference 406, the execution module 722 can be not triggered to execute the access sequence 216. In contrast, if the alert message 410 is not generated, thus, no indication of the layout difference 406 is determined, the execution module 722 can execute the access sequence 216.

For a different example, the execution module 722 can execute the access sequence 216 based on the layout difference 406. As discussed previously, the layout difference 406 can represent the change in the field type 212 from static to dynamic instance of the input field 206. As a result, the execution module 722 can execute the access sequence 216 up to the point where the input field 206 remains the static instance of the input field 206 and stop the access sequence 216 when the access sequence arrives at the dynamic instance of the input field 206.

For further example, the execution module 722 can execute the access sequence 216 based on the field type 212 representing confidential information versus non-confidential information. The field type 212 can represent password input field. The execution module 722 can execute the access sequence 216 up to the point where the access sequence 216 reaches the input field 206 requiring the input of confidential information, such as a password. Once the access sequence 216 is stopped, the alert message 410 can be generated to notify and request the access input 208 to further execute the access sequence 216.

It has been discovered that the content delivery system 100 can execute the access sequence 216 based on the layout difference 406. By factoring the layout difference 406, the content delivery system 100 can reduce the interaction required by the user to access the content 204. But rather, the content delivery system 100 can improve the efficiency for accessing the content 204 by controlling the extent which the access sequence 216 is being executed. As a result, the content delivery system 100 can access the content 204 more efficiently to enhance the user experience of using the first device 102 and the content delivery system 100.

Continuing from the previous example, the execution module 722 can resume the execution of the access sequence 216 once stopped. For example, the execution module 722 can resume the execution of the access sequence 216 from the point where the access sequence 216 was stopped. The execution module 722 can resume the access sequence 216 by identifying the step in the access sequence 216 where the execution was stopped. The step in the access sequence 216 stopped can be identified based on the generation of the alert message 410 for indicating the layout difference 406. Additionally, the execution module 722 can identify the next step in the access sequence 216 after the execution was stopped. For example, if the access input 208 was received for where the access sequence 216 was stopped, the execution module 722 can execute the subsequent step in the access sequence 216 after the access input 208 was received.

The content delivery system 100 can include a debug module 724, which can be coupled to the sequence module 714. The debug module 724 validates the access sequence 216. For example, the debug module 724 can validate the access sequence 216 for determining whether the access sequence 216 can access the content 204.

More specifically, the debug module 724 can receive the access sequence 216 after being generated. The debug module 724 can validate the access sequence 216 to determine whether each step representing the access input 208 can properly access the content 204 by executing the access sequence 216. The proper access of the content 204 can represent the ability for the access sequence 216 to access the content 204 similarly as the user manually entering the access input 208 in each step to access the content 204. The debug module 724 can send a debug result 726 to the notifier module 708 for notifying the user whether the access sequence 216 properly accessed the content 204. The debug result 726 is defined as an outcome of whether the access sequence 216 properly accessed the content 204 or not.

If the debug result 726 includes an outcome that the access sequence 216 properly accessed the content 204, the notifier module 708 can generate the notification 218 notifying the user that the access sequence 216 is ready for use. However, if the debug result 726 includes an outcome that the access sequence 216 did not properly access the content 204, the notifier module 708 can generate the alert message 410 to notify the user to reenter the access input 208 to regenerate the access sequence 216.

For illustrative purposes, the build module 716 the sequence module 714 can generate the access sequence 216, although it is understood that the build module 716 can be operated differently. For example, the build module 716 can update the access sequence 216.

The build module 716 can update the access sequence 216 in a number of ways. For example, the build module 716 can update the access sequence 216 based on the layout difference 406. As discussed previously, the field type 212 can change from static to dynamic instance of the input field 206. The build module 716 can update the access sequence 216 by partitioning the access sequence 216 into two sequences. More specifically, the first sequence can represent the access sequence 216 up to the point for the input into the input field 206 representing the static instance. And the second sequence can represent the access sequence 216 subsequent after the access input 208 is made in the dynamic instance of the input field 206.

For another example, the layout difference 406 can represent the availability of the input field 206 in the content 204. In the previous layout 402, the input field 206 representing the button of “Sign In” can be next to the input field 206 representing the password. And the current layout 404 can include the input field 206 representing the button of “Go” next to the input field 206 of the username. The input field 206 for the password and the button of “Sign In” can be moved to the subsequent page of the content 204.

The access sequence 216 can represent username, password, and “Sign In” for the previous layout 402. The build module 716 can update the access sequence 216 to change the order of the access sequence 216 based on the field type 212 added, removed, or a combination thereof. More specifically, the button of “Go” can represent the field type 212 not requiring confidential information. The build module 716 can update the access sequence 216 to represent username, “Go,” password, and “Sign In” for the current layout 404.

The build module 716 can store a plurality of the access sequence 216 generated and updated in the first storage unit 614. The user or the users with the user's identity 408 can access via the build module 716 to edit, execute, or a combination thereof the access sequence 216.

It has been discovered that the content delivery system 100 can update the access sequence 216 based on the layout difference 406. By factoring the layout difference 406, the content delivery system 100 can reduce the interaction required by the user to customize the access sequence 216. As a result, the content delivery system 100 can access the content 204 more efficiently to enhance the user experience of using the first device 102 and the content delivery system 100.

The physical transformation for determining the context 304 results in the movement in the physical world, such as people using the first device 102, based on the operation of the content delivery system 100. As the movement in the physical world occurs, the movement itself creates additional information that is converted back into updating the activity pattern 302, the access sequence 216, or a combination thereof for the continued operation of the content delivery system 100 and to continue movement in the physical world.

The first software 626 of FIG. 6 of the first device 102 of FIG. 6 can include the content delivery system 100. For example, the first software 626 can include the tracker module 702, the notifier module 708, the behavior module 712, the layout module 718, and the sequence module 714.

The first control unit 612 of FIG. 6 can execute the first software 626 for the tracker module 702 to track the access input 208. The first control unit 612 can execute the first software 626 for the notifier module 708 to generate the notification 218. The first control unit 612 can execute the first software 626 for the behavior module 712 to determine the activity pattern 302. The first control unit 612 can execute the first software 626 for the layout module 718 to determine the layout difference 406. The first control unit 612 can execute the first software 626 for the sequence module 714 to generate the access sequence 216.

The second software 642 of FIG. 6 of the second device 106 of FIG. 6 can include the content delivery system 100. For example, the second software 642 can include the tracker module 702, the notifier module 708, the behavior module 712, the layout module 718, and the sequence module 714.

The second control unit 634 of FIG. 6 can execute the second software 642 for the tracker module 702 to track the access input 208. The second control unit 634 can execute the second software 642 for the notifier module 708 to generate the notification 218. The second control unit 634 can execute the second software 642 for the behavior module 712 to determine the activity pattern 302. The second control unit 634 can execute the second software 642 for the layout module 718 to determine the layout difference 406. The second control unit 634 can execute the second software 642 for the sequence module 714 to generate the access sequence 216.

The content delivery system 100 can be partitioned between the first software 626 and the second software 642. For example, the second software 642 can include the behavior module 712, the notifier module 708, the layout module 718, and the sequence module 714. The second control unit 634 can execute modules partitioned on the second software 642 as previously described.

The first software 626 can include the tracker module 702. Based on the size of the first storage unit 614, the first software 626 can include additional modules of the content delivery system 100. The first control unit 612 can execute the modules partitioned on the first software 626 as previously described.

The first control unit 612 can operate the first communication unit 616 of FIG. 6 to send the access input 208 to the second device 106. The first control unit 612 can operate the first software 626 to operate the location unit 620. The second communication unit 636 of FIG. 6 can send the access sequence 216 to the first device 102 through the communication path 104 of FIG. 10.

The content delivery system 100 describes the module functions or order as an example. The modules can be partitioned differently. For example, the tracker module 702 and the behavior module 712 can be combined. Each of the modules can operate individually and independently of the other modules. Furthermore, data generated in one module can be used by another module without being directly coupled to each other. For example, the sequence module 714 can receive the access input 208 from the tracker module 702.

The modules described in this application can be hardware implementation or hardware accelerators in the first control unit 612 or in the second control unit 634. The modules can also be hardware implementation or hardware accelerators within the first device 102 or the second device 106 but outside of the first control unit 612 or the second control unit 634, respectively.

It has been discovered that the content delivery system 100 generates the access sequence 216 to automate the access input 208 on the first device 102. By generating the access sequence 216, the user of the first device 102 can improve the speed and accuracy for entering the correct value in the input field 206. As a result, the content delivery system 100 can deliver the content 204 more efficiently to enhance the user experience for using the first device 102 and the content delivery system 100.

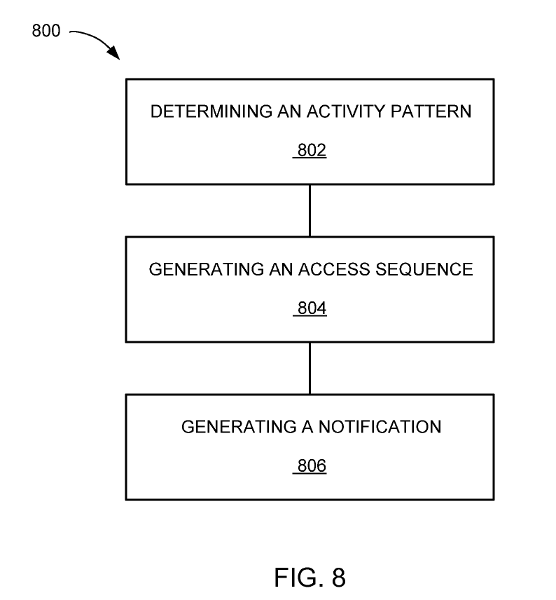

Referring now to FIG. 8, therein is shown a flow chart of a method 800 of operation of a content delivery system 100 in an embodiment of the present invention. The method 800 includes: determining an activity pattern based on an access input in a block 802; generating an access sequence based on the activity pattern in a block 804; and generating a notification otherwise the access sequence is executed for displaying on a device in a block 806.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

1. A content delivery system comprising:
a behavior module configured to determine an activity pattern based on an access input with a control unit;
a build module, coupled to the behavior module, configured to generate an access sequence based on the activity pattern; and
a notifier module, coupled to the build module, configured to generate a notification otherwise the access sequence is executed for displaying on a device.

2. The system as claimed in claim 1 wherein the build module is configured to generate the access sequence includes generating the access sequence based on a current layout of a content.

3. The system as claimed in claim 1 wherein the build module is configured to generate the access sequence includes generating the access sequence based on the access input made in a context.

4. The system as claimed in claim 1 further comprising an execution module, coupled to the notifier module, configured to execute the access sequence based on validating a user's identity for displaying on the device.

5. The system as claimed in claim 1 wherein the notifier module includes a response module configured to generate an interactive message based on a field type available on a content.

6. The system as claimed in claim 1 wherein the build module is configured to generate
an access sequence based on the activity pattern for sequencing the access input.

7. The system as claimed in claim 6 wherein the notifier module includes an interruption module configured to generate an alert message based on a layout difference for notifying an inability to continue executing the access sequence.

8. The system as claimed in claim 6 further comprising a debug module, coupled to the build module, configured to validate the access sequence by checking whether the access sequence accessed a content.

9. The system as claimed in claim 6 further comprising:
a layout module, coupled to the build module, configured to determine a layout difference based on a field selection available in a previous layout versus a current layout; and
wherein:
the build module is configured to update the access sequence based on the layout difference for accessing the content.

10. The system as claimed in claim 6 further comprising:
a layout module, coupled to the build module, configured to determine a layout difference of a content based on comparing a current layout to a previous layout; and
wherein:
the notifier module is configured to generate the notification based on the layout difference otherwise the access sequence is executed for displaying on the device.

11. A method of operation of a content delivery system comprising:
determining an activity pattern based on an access input;
generating an access sequence based on the activity pattern;
generating a notification otherwise the access sequence is executed for displaying on a device.

12. The method as claimed in claim 11 wherein generating the access sequence includes generating the access sequence based on a current layout of a content.

13. The method as claimed in claim 11 wherein generating the access sequence includes generating the access sequence based on the access input made in a context.

14. The method as claimed in claim 11 further comprising executing the access sequence based on validating a user's identity for displaying on the device.

15. The method as claimed in claim 11 wherein generating the notification includes generating an interactive message based on a field type available on a content.

16. A method of operation of a content delivery system comprising:
determining an activity pattern based on an access input;
generating an access sequence based on the activity pattern for sequencing the access input; and
generating a notification otherwise the access sequence is executed for displaying on a device.

17. The method as claimed in claim 16 wherein generating the notification includes generating an alert message based on a layout difference for notifying an inability to continue executing the access sequence.

18. The method as claimed in claim 16 further comprising validating the access sequence by checking whether the access sequence accessed a content

19. The method as claimed in claim 6 further comprising:
determining a layout difference based on a field selection available in a previous layout versus a current layout; and
updating the access sequence based on the layout difference for accessing the content.

20. The method as claimed in claim 6 further comprising:
for determining a layout difference of a content based on comparing a current layout to a previous layout; and
wherein:
generating the notification includes generating the notification based on the layout difference otherwise the access sequence is executed for displaying on the device.
